(19) United States
(12) Patent Application Publication
(10) Pub. No.: US 2015/0326861 A1
(43) Pub. Date: Nov. 12, 2015

(54) MOBILE ELECTRONIC DEVICE AND VIDEO COMPENSATION METHOD THEREOF

(71) Applicant: Acer Incorporated, New Taipei City (TW)

(72) Inventors: Hsing-Lung Chung, New Taipei City (TW); Yung-Jen Lin, New Taipei City (TW); Jian-Wei Lee, New Taipei City (TW)

(21) Appl. No.: 14/705,976

(22) Filed: May 7, 2015

(30) Foreign Application Priority Data
May 8, 2014 (TW) 103116405

(51) Int. Cl. H04N 19/132; H04L 12/26; H04W 24/08

(52) U.S. Cl. CPC H04N 19/132; H04W 24/08; H04L 43/0835; H04L 43/0858

(57) ABSTRACT

A mobile electronic device, which includes a network unit, a packet detecting unit, a bandwidth monitoring unit, a media access control (MAC) layer monitoring unit and a processing unit. The network unit receives a video stream through a wireless network, wherein the video stream includes a plurality of packets. The packet detecting unit is coupled to the network unit, and monitors a packet receiving condition of the network unit. The bandwidth monitoring unit is coupled to the network unit, and monitors a bandwidth of the network unit for receiving the video stream. The MAC layer monitoring unit is coupled to the network unit, and monitors a plurality of MAC layer information data of the network unit. The processing unit determines whether to execute a image interpolation procedure to the video stream according to the packet receiving condition, the bandwidth and/or the MAC layer information data.

### CROSS-REFERENCE TO RELATED APPLICATION

This application claims the priority benefit of Taiwan application serial no. 103116405, filed on May 8, 2014. The entirety of the above-mentioned patent application is hereby incorporated by reference herein and made a part of this specification.

### BACKGROUND OF THE INVENTION

1. Field of the Invention

The invention relates to an electronic device, and more particularly, relates to a mobile electronic device and a video compensation method thereof.

2. Description of Related Art

With advances in wireless network technologies, users may use mobile electronic devices (such as smart phones, tablet computers and so on) to receive a video stream through a wireless network for viewing video contents in real time. However, users often encounter situations in which the video contents are not running smoothly, or parts of the video contents are blur. The main reason is that, when a transmitting amount of the wireless network is overly massive, a buffer space of an access point of Internet (e.g., an access point of a local area wireless network or a queue in a base station of a mobile network) becomes insufficient, resulting that a part of packets must be discarded, and the discarded packets include the part of the video contents. Another possible reason is that, the wireless network is under influence from the outside to cause signal interference or attenuation, which leads to packet loss during transmission.

### SUMMARY OF THE INVENTION

The invention is directed to a mobile electronic device and a video compensation method, and capable of determining whether to execute video compensation for video frames by monitoring network environment.

A mobile electronic device of the invention includes a network unit, a packet detecting unit, a bandwidth monitoring unit, a media access control layer monitoring unit and a processing unit. The network unit receives a video stream through a wireless network, wherein the video stream includes a plurality of packets. The packet detecting unit is coupled to the network unit, and monitors a packet receiving condition of the network unit. The bandwidth monitoring unit is coupled to the network unit, and monitors a bandwidth of the network unit for receiving the video stream. The MAC layer monitoring unit is coupled to the network unit, and monitors a plurality of MAC layer information data of the network unit. The processing unit is coupled to the network unit, the packet detecting unit, the bandwidth monitoring unit and the media access control layer monitoring unit, and determines whether to execute an image interpolation procedure to the video stream according to the packet receiving condition, the bandwidth and/or the media access control layer information data.

A video compensation method of the invention is adapted to a mobile electronic device, wherein the mobile electronic device receives a video stream including a plurality of packets through a wireless network, and the method includes the following steps. First, a packet receiving condition of the mobile electronic device from the wireless network is monitored. Next, a bandwidth for receiving the video stream is monitored. Then, a plurality of media access control layer information data are monitored. Lastly, whether to execute an image interpolation procedure to the video stream is determined according to the packet receiving condition, the bandwidth and/or the media access control layer information data.

Based on above, the invention provides a mobile electronic device and a video compensation method thereof, capable of determining whether it is necessary to execute the image interpolation procedure to the current video according to the packet receiving condition and the network information data.

To make the above features and advantages of the disclosure more comprehensible, several embodiments accompanied with drawings are described in detail as follows.

### BRIEF DESCRIPTION OF THE DRAWINGS

FIG. 1 is a functional block diagram illustrating a mobile electronic device according to an embodiment of the invention.

FIG. 2A to FIG. 2C are schematic diagrams illustrating packet transmission of the video stream according an embodiment of the invention.

FIG. 3 is a flowchart illustrating a video compensation method according an embodiment of the invention.

### DESCRIPTION OF THE EMBODIMENTS

In the invention, when a user is using a mobile electronic device for viewing video contents, the mobile electronic device could determine whether execute an image compensation mechanism at local end according to a network condition at the time. When the network is unstable or a delay time for the network to transmit the packets is too long, or even when packet loss occurs, the mobile electronic device may execute an image interpolation procedure according to the packets already received, so that the images viewed by the user can be smoother.

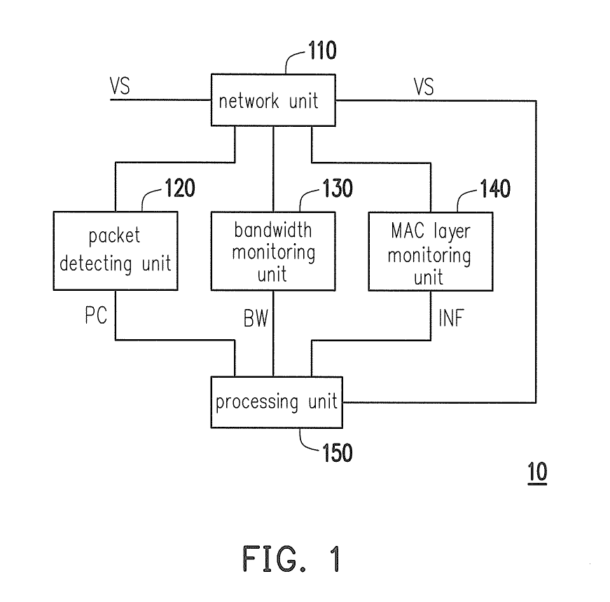

FIG. 1 is a functional block diagram illustrating a mobile electronic device according to an embodiment of the invention. Referring to FIG. 1, a mobile electronic device 10 of the invention includes a network unit 110, a packet detecting unit 120, a bandwidth monitoring unit 130, a media access control layer monitoring unit 140 and a processing unit 150. The network unit 110 receives a video stream VS through a wireless network such as a local area wireless network or a mobile network, wherein the video stream VS includes a plurality of packets. In fact, the video stream VS may include a plurality of frames compressed by different compression modes, such as I frame, P frame or B frame. Display content of each frame may be further decomposed into the packets. A video source (a media provider, such as a remote server) may stream the packets into the video stream for transmitting to the mobile electronic device 10 through the wireless network connected to Internet. In other words, each of the packets include a part of the display contents in one single frame.

The packet detecting unit 120 is coupled to the network unit 110, and monitors a packet receiving condition PC of the network unit 110. The bandwidth monitoring unit 120 is coupled to the network unit 110, and monitors a bandwidth BW of the network unit 110 for receiving the video stream VS. The media access control layer monitoring unit 140 is coupled to the network unit 110, and monitors a plurality of media access control layer information data INF of the network unit 110. The processing unit 150 is coupled to the network unit 110, the packet detecting unit 120, the bandwidth monitoring unit 130 and the media access control layer monitoring unit 140, and determines whether to execute the image interpolation procedure to the video stream VS according to the packet receiving condition PC, the bandwidth BW and/or the media access control layer information data INF. In other words, the processing unit 150 could determine whether it is necessary to execute the image interpolation procedure to the video stream VS according to part or all of the packet receiving condition PC, the bandwidth BW and/or the media access control layer information data INF. Descriptions regarding processes to the packet receiving condition PC, the bandwidth BW and/or the media access control layer information data INF are provided as follows.

In the present embodiment, the packet receiving condition monitored by the packet detecting unit 120 may include a delay time count between the packets, monitoring of continuity of the packets, and a packet loss amount. The display contents for the user to view cannot be interrupted because the video stream is a transmission in real time, and thus a time used for transmitting the packets is quite tight. If a time interval between one packet and another packet suddenly becomes longer, it indicates that problems such as packet loss may have occurred during the transmission. In addition, if packet numbers of the packets being received is discontinuous, it indicates that the packet loss has been occurred therein. Possible conditions for the packet loss are provided below by reference with drawing.

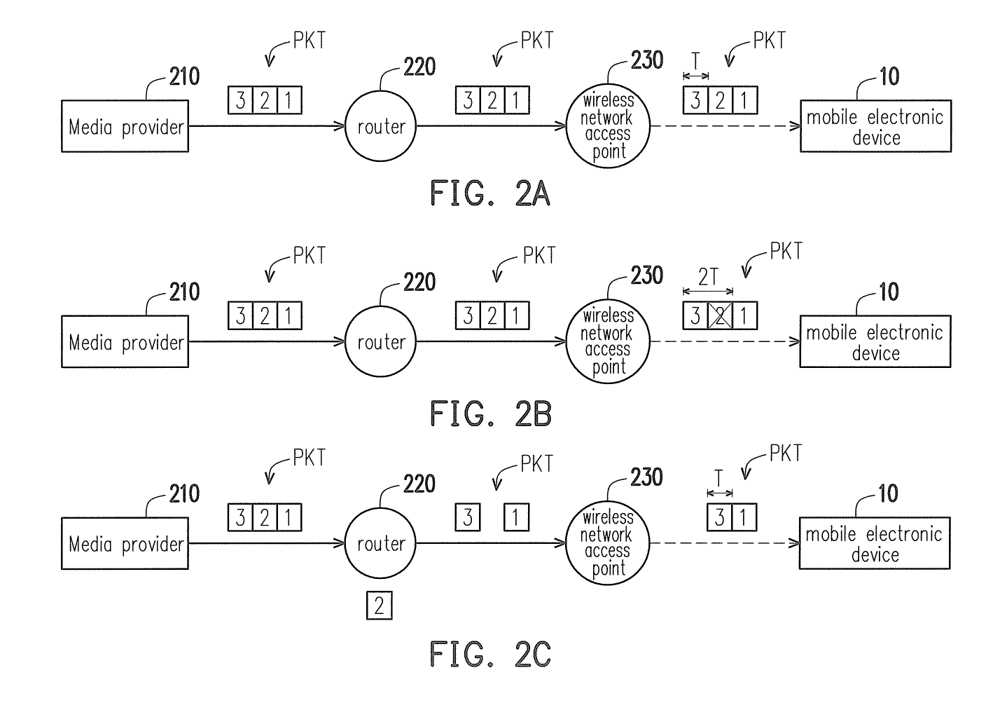

FIG. 2A to FIG. 2C are schematic diagrams illustrating packet transmission of the video stream according an embodiment of the invention. In FIG. 2A to FIG. 2C, packets PKT #1 to PKT#3 are used to represent the packets transmitted to the mobile electronic device (e.g., the mobile electronic device 10 depicted in FIG. 1).

Referring to FIG. 2A, a condition in which the packets PKT #1 to PKT#3 are normally transmitted is illustrated in FIG. 2A. Herein, the packets PKT #1 to PKT#3 are transmitted to a wireless network access point 230 from a media provider 210 (e.g, a network server) through a router 220 in a wired manner. The mobile electronic device 10 then receives the packets PKT #1 to PKT#3 from the wireless network access point 230 through a wireless network. In this embodiment, because the video stream VS as mentioned above requires the packets to be transmitted in real time, the mobile electronic device 10 must have the packets PKT #1 to PKT#3 received within a time 3T (i.e., one packet is corresponding one time unit T). The packet detecting unit 120 may set a threshold of the delay time count to be equal to or slightly greater than a time T, so that when a time for receiving one single packet exceeds the time T, the processing unit 150 may then determine that the packet loss may have occurred.

In a condition depicted in FIG. 2B, a buffer space of a queue in the wireless network access point 230 is sufficient because an overall transmitting amount of data for the wireless network access point 230 is overly massive, such that a part of the packets (e.g., the packet PKT#2 depicted in FIG. 2B) in the video stream is discarded by the wireless network access point 230. Or, a connection status between the wireless network access point 230 and the mobile electronic device 10 is under influence from the atmosphere, which leads to the packet loss in the wireless network environment.

Therefore, when receiving the packets PKT from the wireless network access point 230 through the wireless network, after the packet PKT#1 is received, the mobile electronic device 10 may only complete receiving of the packet PKT#3 after waited for a time 2T. In this case, the packet detecting unit 120 transmits the packet receiving condition PC including the delay time count being the time 2T to the processing unit 150. When the processing unit 150 determines that the delay time count is greater than a preset time, whether it is necessary to execute the image interpolation procedure to the video stream VS may be determined.

In a condition depicted in FIG. 2C, a buffer space of a queue in the router 220 is sufficient because an overall transmitting amount of data for the router 220 is overly massive, such that a part of the packets (e.g., the packet PKT#2 depicted in FIG. 2C) in the video stream is discarded by the router 220. When the wireless network access point 230 receives the remaining packets PKT#1 and PKT#3, the packet PKT#3 may transmitted immediately after the packet PKT#1 based on the demand for transmission in real time. Although the packet detecting unit 120 of the mobile electronic device 10 may not monitor any delay time (i.e, the delay time count is null), but the packet detecting unit 120 may determine that the received packets are discontinuous packets when checking the continuity of the packets (i.e., sequence number of the received packets are not in sequence). In this case, the packet detecting unit 120 may transmit the packet receiving condition PC which further includes a message of the discontinuous packets to the processing unit 150. When the message of the discontinuous packets is received, the processing unit 150 would be informed that the packet loss has occurred in currently received video stream VS.

On the other hand, when the packet loss occurs (e.g., when the delay time count is greater than the preset time and/or when the packets are determined as the discontinuous packets when checking the contiguity of the packets), the packet detecting unit 120 may also increase a value of the packet loss amount and transmit the packet receiving condition PC which also includes the packet loss amount to the processing unit 150. The processing unit 150 only needs to determine whether to execute the image interpolation procedure to the video stream VS when the packet loss amount is greater than a preset amount. Based on demands in practical implementations, the processing unit 150 may determine whether to execute the image interpolation procedure to the video stream VS according to a part or all of the delay time count, the message of the discontinuous packets and the packet loss amount as included in the packet receiving condition PC, which are not particularly limited by the invention.

When the processing unit 150 determines to execute the image interpolation procedure to the video stream VS according to a part or all among the delay time count, the message of the discontinuous packets and the packet loss amount, the processing unit 150 may decide a display delay time according to a part or all among the delay time count, the message of the discontinuous packets and the packet loss amount (e.g., the longer the display delay time is, the longer the delay time count is), and execute the image interpolation procedure to the video stream VS within the display delay time, so as to avoid the fluency for the user in viewing the video contents from being influenced.

Referring back to FIG. 1, the bandwidth monitoring unit 130 continues to monitor the bandwidth of a connection between the mobile electronic device 10 and the wireless network access point 230 (a connection for receiving the video stream VS). When the bandwidth is overly low (e.g., lower than a preset threshold), the processing unit 150 sends a request for reducing data transmission through the network unit 110 to the media provider 210 for requesting the media provider 230 to reduce a transmitting amount of the packets, and executes the image interpolation procedure to the video stream VS. For example, in normal condition, the media provider 210 transmits packets numbered 1 to 4 to the mobile electronic device 10. When the media provider 210 receives afore-said request for reducing data transmission, the media provider 210 only transmits the packets numbered 1 and 4 to the mobile electronic device 10. When the packets numbered 1 and 4 are received, the mobile electronic device 10 may then generate the packets numbered 2 and 3 by using the image interpolation procedure.

In another embodiment of the invention, the wireless network access point 230 is capable of analyzing the packets. When the request for reducing the transmission data is sent to the wireless network access point 230, the wireless network access point 230 may then reduce transmitting amount of the packets. For example, according to contents of an algorithm, the wireless network access point 230 may selectively transmit a part of the packets in the video stream VS to the mobile electronic device 10. Nevertheless, the invention is not limited to above-said embodiments. When the processing unit 150 determines to execute the image interpolation procedure to the video stream VS according to the current bandwidth, the processing unit 150 may determine a display delay time according to the current bandwidth and the request for reducing data transmission (e.g., the longer the display delay time is as the bandwidth is lower), and execute the image interpolation procedure to the video stream VS within the display delay time, so as to avoid the fluency for the user in viewing the video contents from being influenced.

In the embodiment depicted in FIG. 1, the wireless network is compliance with IEEE 802.11 protocol standard. The media access control layer (MAC) monitoring unit 140 may monitor a MAC layer information data provided by a MAC layer of the network unit 110 as a basis for analysis. The MAC layer information data may at least include link speed (LS), transmitted fragment count (TFC), failed count (FC), received fragment count (RFC) and FCS error count (FEC). Through said information data, the processing unit 150 would be understand a connection status of current connection (a connection between the wireless network access point 230 and the mobile electronic device 10). In an embodiment of the invention, the processing unit 150 may further calculate a rate of success or failure in transmitting the packets according afore-said MAC layer information data, and thereby estimating whether it is necessary to execute the image interpolation procedure to the video stream VS.

In an embodiment of the invention, a packet error rate (PER) as mentioned above may be represented by a formula (1) as follows.

PER=(FC+FEC)/(TFC+FC+RFC+REC) (1)

Accordingly, the processing unit 150 may determine whether to execute the image interpolation procedure to the video stream VS by calculating a packet error rate and determining whether the packet error rate is higher than a present threshold. When the processing unit 150 determines to execute the image interpolation procedure to the video stream VS according to the current packet error rate, the processing unit 150 may decide a display delay time according to the current packet error rate (e.g., the longer the display delay time is, the higher the packet error rate is), and execute the image interpolation procedure to the video stream VS within the display delay time, so as to avoid a fluency for the user in viewing the video contents from being influenced.

In other words, by obtaining a part or all of information data of the packet receiving condition PC, the bandwidth BW and/or the media access control layer information data INF, the processing unit 150 is capable of determining whether it is necessary to execute the image interpolation procedure to the video stream VS. When it is determined to execute the image interpolation procedure to the video stream VS according to a part or all of information data in the packet receiving condition PC, the bandwidth BW and/or the media access control layer information data INF, the processing unit 150 may further obtain one or more lost packets by analyzing afore-said information data.

For example, the video stream VS includes 10 frames, wherein the frame numbered 1 is the I frame, whereas the frames numbered 2 to 10 are P frames. Through said analysis, the processing unit 150 could be informed that the P frames numbered 3, 4, 9 include the lost packets. Accordingly, during the image interpolation procedure, the processing unit 150 may execute an interpolation by using received parts in the P frames numbered 2 and 5, or the P frames numbered 3 and 4 to obtain lost parts in the P frames numbered 3 and 4. Similarly, the processing unit 150 may execute an interpolation by using received parts in the P frames numbered 8 and 10, or the P frames numbered 9 to obtain lost parts in the P frames numbered 3 and 4. As a result, the condition in which video is broken or not smooth when displaying the video of the video stream VS may be improved.

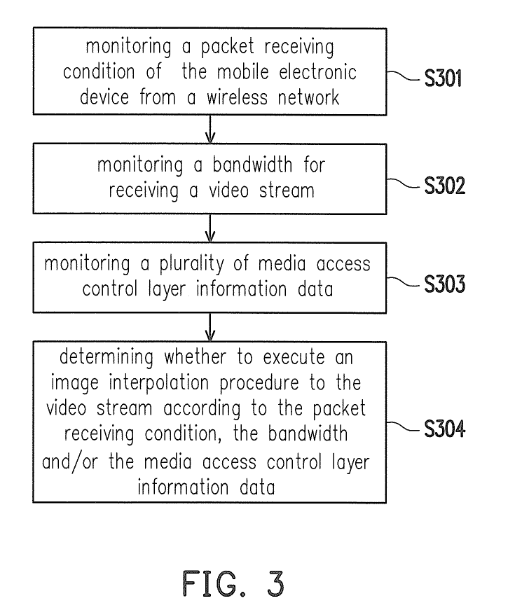

The invention also provides a video compensation method adapted to a mobile electronic device, wherein the mobile electronic device (e.g., the mobile electronic device 10) receives a video stream including a plurality of packets through a wireless network. FIG. 3 is a flowchart illustrating a video compensation method according an embodiment of the invention. Referring to FIG. 3, first, in step S301, a packet receiving condition of the mobile electronic device from the wireless network is monitored. Next, in step S302, a bandwidth for receiving the video stream is monitored. Then, in step S303, a plurality of media access control layer information data are monitored. Lastly, in step S304, whether to execute a image interpolation procedure to the video stream is determined according to the packet receiving condition, the bandwidth and/or the media access control layer information data. Detailed implementation regarding the video compensation method may refer to the embodiments depicted in FIG. 2A to FIG. 2C, thus related description thereof is omitted hereinafter.

In summary, the invention provides a mobile electronic device and a video compensation method, capable of determining whether it is necessary to execute the image interpolation procedure to image frame in the video stream by monitoring the conditions of the network environment. Through the image interpolation procedure, influences of lost packets to the video (e.g., the video is broken or not smooth) may be reduced, so as to reduce discomforts of the user when viewing the video in a poor network environment. In the invention, the mobile electronic device may reduce the transmitting amount of the packets, so that the bandwidth of the wireless network may be used more effectively.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A mobile electronic device comprising:
a network unit, receiving a video stream through a wireless network, wherein the video stream comprising a plurality of packets;
a packet detecting unit, coupled to the network unit, monitoring a packet receiving condition of the network unit;
a bandwidth monitoring unit, coupled to the network unit, and monitoring a bandwidth of the network unit for receiving the video stream;
a media access control (MAC) layer monitoring unit, coupled to the network unit, and monitoring a plurality of media access control layer information data of the network unit; and
a processing unit, coupled to the network unit, the packet detecting unit, the bandwidth monitoring unit and the media access control layer monitoring unit, and determining whether to execute an image interpolation procedure to the video stream according to the packet receiving condition, the bandwidth and/or the media access control layer information data.

2. The mobile electronic device of claim 1, wherein:
when executing the image interpolation procedure to the video stream is determined, the processing unit analyzes at least one lost packet in the video stream, and executes the image interpolation procedure to the video stream according to the at least one lost packet.

3. The mobile electronic device of claim 1, wherein:
the packet receiving condition includes a delay time count between the packets, a continuity of the packets and a packet loss amount;
when the delay time count is greater than a preset time, the packets are discontinuous and/or the packet loss amount is greater than a preset amount, the processing unit determines a display delay time according to the delay time and the packet loss amount, and executes the image interpolation procedure to the video stream within the display delay time.

4. The mobile electronic device of claim 1, wherein
when the bandwidth is lower than a preset threshold, the processing unit sends a request for reducing data transmission through the network unit, and executes the image interpolation procedure to the video stream.

5. The mobile electronic device of claim 1, wherein
the processing unit calculates a packet error rate according to the media access control layer information data; and
when the packet error rate is higher than a preset threshold, the processing unit generates a display delay time according to the packet error rate, and executes the image interpolation procedure to the video stream within the display delay time.

6. A video compensation method, adapted to a mobile electronic device, wherein the mobile electronic device receives a video stream comprising a plurality of packets through a wireless network, and the method comprises:
monitoring a packet receiving condition of the mobile electronic device from the wireless network;
monitoring a bandwidth for receiving the video stream;
monitoring a plurality of media access control layer information data; and
determining whether to execute an image interpolation procedure to the video stream according to the packet receiving condition, the bandwidth and/or the media access control layer information data.

7. The video compensation method of claim 6, wherein after the step of determining whether to execute the image interpolation procedure to the video stream, the method further comprises:
when executing the image interpolation procedure to the video stream is determined, analyzing at least one lost packet in the video stream, and executing the image interpolation procedure to the video stream according to the at least one lost packet.

8. The video compensation method of claim 6, wherein the packet receiving condition includes a delay time count between the packets, a continuity of the packets and a packet loss amount, and the step of determining whether to execute the image interpolation procedure to the video stream according to the packet receiving condition, the bandwidth and/or the media access control layer information data comprises:
when the delay time count is greater than a preset time, the packets are discontinuous and/or the packet loss amount is greater than a preset amount, determining a display delay time according to the delay time and the packet loss amount, and executing the image interpolation procedure to the video stream within the display delay time.

9. The video compensation method of claim 6, wherein the step of determining whether to execute the image interpolation procedure to the video stream according to the packet receiving condition, the bandwidth and/or the media access control layer information data comprises:
when the bandwidth is lower than a preset threshold, sending a request for reducing data transmission, and executing the image interpolation procedure to the video stream.

10. The video compensation method of claim 6, wherein the step of determining whether to execute the image interpolation procedure to the video stream according to the packet receiving condition, the bandwidth and/or the media access control layer information data comprises:
calculating a packet error rate according to the media access control layer information data; and
when the packet error rate is higher than a preset threshold, generating a display delay time according to the packet error rate, and executing the image interpolation procedure to the video stream within the display delay time.
